(19) United States
(12) Patent Application Publication
(10) Pub. No.: US 2004/0121764 A1
(43) Pub. Date: Jun. 24, 2004

(54) Dynamic device configuration through automated domain detection

(76) Inventor: Juan S. Rivero, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/329,216

(22) Filed: Dec. 23, 2002

(51) Int. Cl. H04M 3/00

(52) U.S. Cl. 455/418; 455/420

(57) ABSTRACT

An apparatus and associated methods for dynamic device configuration through automated domain detection are generally described.

### TECHNICAL FIELD

Embodiments of the invention generally relate to electronic appliances and, more particularly to an apparatus and associated methods for automated device configuration.

### BACKGROUND

Portable, or mobile, electronic appliances (or devices) such as, for example, laptop or palmtop computers, personal digital assistants (PDA), cellular telephones, two-way pagers, and the like are designed to be used in multiple operational environments (colloquially referred to as domains). Each of the domains may support a number of other users and their electronic devices as well as network-based resources (e.g., printers, file servers, application servers, etc.), which may or may not be available to any given user (and associated appliance) entering the domain. Conventional devices often require that a user manually “log-in” to such domains in order to “participate” in and/or share the resources of the domain.

While this conventional model may work for more sophisticated users, it is often prohibitively difficult for novice users of such increasingly intelligent devices to seamless traverse multiple domains. That is, not all consumers of such devices have the necessary technical skill to understand the concept of operational domains, or how to access and, consequently, share resources as they traverse such domains.

### BRIEF DESCRIPTION OF THE DRAWINGS

Embodiments of the present invention is illustrated by way of example, and not by way of limitation, in the figures of the accompanying drawings in which like reference numerals refer to similar elements and in which:

FIG. 1 is a block diagram of an example operational topology within which embodiments of the present invention may be practiced;

FIG. 2 is a block diagram of an example configuration agent architecture, in accordance with but one example embodiment of the invention;

FIG. 3 is a flow chart of an example method of managing access privileges of one or more associated electronic appliance(s), according to one example embodiment of the invention;

FIG. 4 is a block diagram of an example electronic appliance suitable for use in accordance with one example embodiment of the present invention;

FIG. 5 is a block diagram of an example implementation according to one embodiment of the present invention; and

FIG. 6 is a block diagram of an example storage medium including content which, when executed by an accessing appliance, causes the appliance to implement one or more aspects of an embodiment of the invention.

### DETAILED DESCRIPTION

Embodiments of the invention are generally directed to dynamic device configuration through automated domain detection. In this regard, according to one example embodiment, a configuration agent is introduced. In accordance with such an embodiment, the configuration agent detects indication signals generated by a host domain, and attempts to identify the domain from the detected indication signal. If successful, the configuration agent may selectively set/modify one or more operating characteristics of the associated electronic appliance. In particular, in accordance with but one example implementation, the configuration agent may well set and/or modify communication parameters, access privileges, user interface parameters and the like of the electronic appliance to enable the host appliance to share information and resources with at least a subset of elements of the identified domain. In this regard, configuration agent enables a user of a host appliance to traverse the resources of multiple domain(s) with reduced manual intervention by the user.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

### Example Network Environment

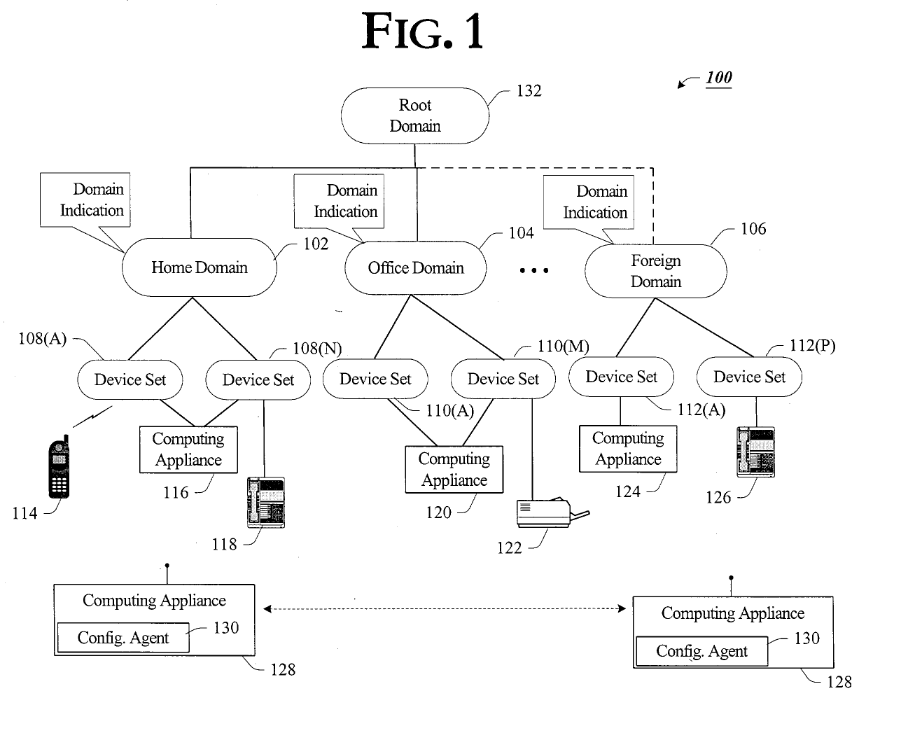

FIG. 1 illustrates a block diagram of an example operating topology within which embodiments of the present invention may well be practiced. In accordance with the illustrated example embodiment of FIG. 1, a hierarchical topology 100 is depicted comprising a number of operating environments such as, by mere example, a home domain 102, office domain 104 and one or more foreign domain(s) 106. Within each domain 102-106 may exist one or more device set(s) (or, sub-domains) 108A . . . N, 110A . . . M, and 112A . . . P. Within each domain 102-106 and/or device set 108-112 may exist one or more electronic appliances 114-128 such as, by mere example, computing appliances, wireless and/or wired communication devices, imaging devices, multimedia appliances, networking appliances, household appliances, and the like, logically, or physically coupled as depicted, although the scope of the present invention is not limited in this respect.

Appliances within a given device set 108, 110, 112 may interact with other appliances within the same device set. Some appliances 116, 120 may belong to multiple device sets within a domain and, in this regard, may access and share information among and between appliances within such device set(s). In addition, appliances may belong to a root domain 132, which traverses all known (i.e., non-foreign) domains. In such a case, the appliance may have a single configuration and access privileges across all domains 102-106.

In accordance with the illustrated example of FIG. 1, at least one of the electronic appliances, e.g., computing appliance 128 is depicted comprising a configuration agent 130, in accordance with one aspect of the invention. As will be developed more fully below, configuration agent 130 within (or, otherwise associated with) an appliance (e.g., 128) may receive an indication from one or more operational domain(s) 102-106. In response, configuration agent 130 may attempt to identify the one or more domains based, at least in part on the received indication. If the domain is identified, configuration agent 130 may retrieve an access profile associated with the domain and, in accordance with information contained within the profile, selectively modifies one or more operating characteristics of the host appliance 128 for use within the identified domain.

According to one example embodiment, if configuration agent 130 is unable to identify (or, resolve) the source of the received indication (i.e., a foreign domain 106), configuration agent 130 may invoke an interface to enable a user or administrator to configure the device for use within the newly identified domain. Configuration agent 130 may store the newly configured access profile for subsequent use, at which point the foreign domain would no longer be foreign to the configuration agent 130. Thus, as computing appliance 128 traverses (denoted by the dashed line) domains 102, 104 and 106, configuration manager 130 may dynamically modify one or more operational parameters such as, e.g., access parameters, application support, user interface settings, communication settings, and the like of the computing appliance 128 to suit a host domain (i.e., 102, 104 or 106).

As introduced above, in accordance with one aspect of the example embodiment of the present invention, domains 102-106 include at least one element endowed with a wireless transmitter that generates a wireless signal, colloquially referred to herein as a heartbeat. This wireless signal, or heartbeat, provides some indication as to an identity of the domain within which the element resides. The element may well be an electronic appliance such as, e.g., a computing system, communications device, networking component (e.g., WLAN access point, wireless router, hub, etc.), kitchen appliance, multimedia component (e.g., digital versatile disk (DVD) or compact disk (CD) player), electronic sensor, and the like.

Similarly, the wireless signal—the “heartbeat” of the domain—may well be any one or more of a number of wireless signals including, but not limited to, a narrowband, wideband or ultra-wideband radio frequency (RF) signal, an infra-red (IR) signal, and the like. According to one example implementation, the heartbeat may be generated for another purpose or in accordance with other domain functions such as, for example, wireless local area network (WLAN) support, wireless telephony support, and the like already existing within a given domain. In other embodiments, a dedicated transmission of the heartbeat is established by one or more elements within each domain 102-106.

In accordance with one embodiment of the invention, two devices which belong to a common domain may encounter each other while away from the domain and, as such, do not receive an indication signal (heartbeat) from the domain. According to one example embodiment, configuration agent 130 may announce its presence within a limited transmission area, enabling an ad-hoc domain between the devices.

### Example Configuration Agent Architecture

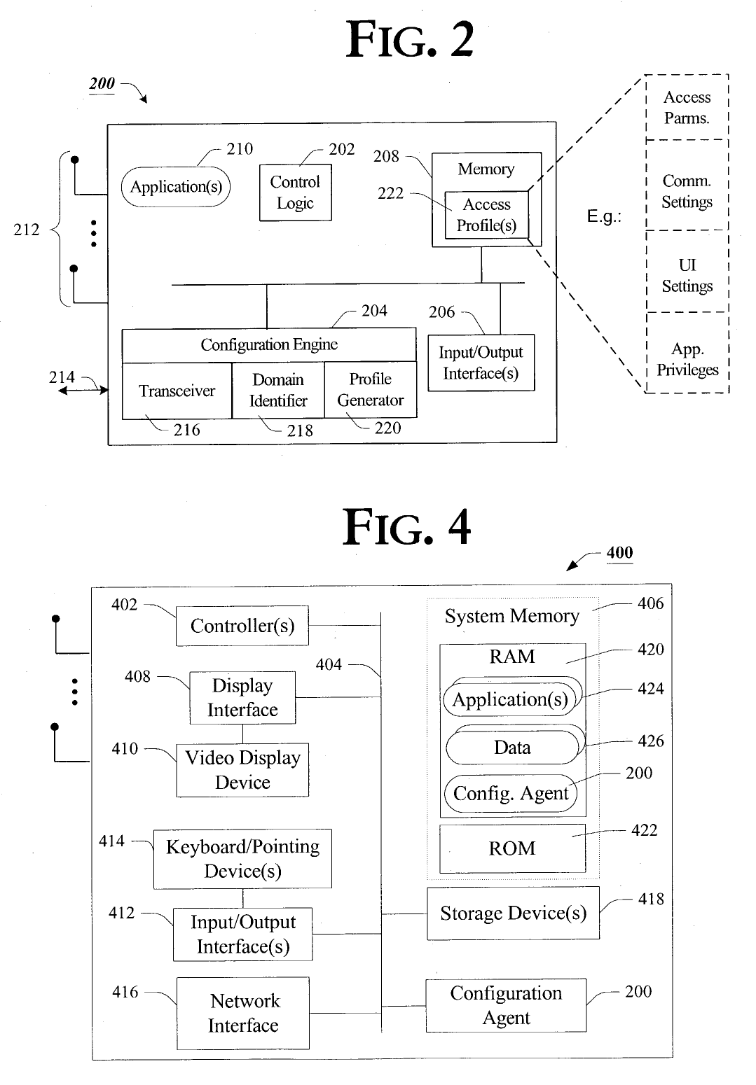

FIG. 2 is a block diagram of an example configuration agent architecture, in accordance with but one example embodiment of the present invention. As depicted in FIG. 2, configuration agent 200 is presented comprising one or more of control logic 202, a configuration engine 204, memory 206, one or more input/output interface(s) 208, one or more antenna(e) 212 and, optionally, one or more applications 210, coupled as depicted. In accordance with the illustrated example embodiment, configuration engine 204 is depicted comprising a transceiver 216, a domain identifier function 218 and a profile generator function 220, while memory 208 is depicted comprising one or more access profile(s) 222.

As used herein, control logic 202 may control the overall operation of configuration agent 200. As discussed more fully below, control logic 202 may well interface with controllers, an operating system or application(s) of one or more host appliance(s) (e.g., host appliance 128) to invoke the features of configuration engine 204. As used herein, control logic 202 is intended to represent any of a wide variety of control elements including, but not limited to, one or more of a microprocessor, a microcontroller, a field programmable gate array (FPGA), a digital signal processor (DSP), and/or software or firmware to implement one or more control functions generally attributed to control logic 202 herein. Indeed, any of the one or more elements of configuration agent 200 may well be implemented in hardware, software, firmware or a combination thereof.

As introduced above, configuration engine 204 is depicted comprising one or more transceiver(s) 216, domain identifier 218 and profile generator 220, which may be selectively invoked (by, e.g., control logic 202) to manage the configuration of a host electronic appliance (e.g., computing appliance 128) based, at least in part, on the detected operational environment of the host appliance.

According to one embodiment, transceiver 216 includes at least one or more receiver element(s) (not particularly illustrated). According to one example embodiment, configuration agent 204 may leverage receiver element(s) of a host electronic appliance, wherein transceiver 216 is an interface between configuration agent 200 and the remote receiver(s). Any of a number of receiver architectures may well be used by configuration engine 204 including, but not limited to, radio frequency (RF) receivers, infrared (IR) receivers, and the like. The receiver(s) may be selectively invoked (e.g., by control logic 202) to receive an indication signal (heartbeat) from a host domain. As noted above, the indication signal may be a signal generated in accordance with another domain function such as, e.g., a control signal generated in the normal course of wireless local area network (WLAN) management by an access point. In alternate embodiments the indication signal may be dedicated to the purpose of announcing domain identity to configuration agents 200.

According to one embodiment, transceiver 216 may also include one or more transmitter elements (not particularly denoted). According to one example embodiment, configuration agent may utilize transmitter element(s) of a host electronic appliance, wherein transceiver 216 may provide an interface between configuration agent 200 and the remote transmitter(s). Any of a number of transmitter architectures may well be invoked to communicate with one or more elements of a host domain. According to one example embodiment, described more fully below, one or more transmitter elements associated with transceiver 216 may be selectively invoked by profile generator 220 when configuring a foreign domain for use with a host electronic appliance.

According to one embodiment, domain identifier 218 may analyze an indication signal received from one or more domains to identify an operating environment of the host electronic appliance. According to one example embodiment, domain identifier 218 reads at least a subset of the received indication for information denoting a particular host domain. If information identifying a particular domain is detected and recognized, domain identifier 218 accesses memory 208 (perhaps through control logic 202) to retrieve one or more access profile(s) associated with the detected domain. If multiple domains are detected, domain identifier 218 may invoke additional selection criteria such as, analysis of signal characteristics (e.g., receive signal strength, signal to noise ratio, etc.), permissiveness of access profile(s) associated with the identified domain(s), and the like in selecting one of the detected host domain(s).

In response to the identification of the host domain, control logic 202 may selectively modify one or more operational parameters of the host appliance, in accordance with the configuration information contained within the access profile 222 associated with the identified domain. According to one example embodiment, the configuration information may include one or more of communication parameters (access frequency, access technology, etc.), device set identifiers, application availability, appliance personality, etc. In one embodiment, one or more of such operational parameters are set by control logic 202 in cooperation with an operating system (OS) of the host appliance.

According to one example embodiment, the configuration settings within an access profile 222 associated with an identified domain may be time limited, e.g., to permit limited access to accommodate limited duration access needs (i.e., meetings, etc.). According to one embodiment, the configuration settings within an access profile 222 may evidence, or enable, various Quality-of-Service (QoS) parameters such as, e.g., communication rate (bandwidth) afforded to domain participants, etc.

Profile generator 220 may be selectively invoked (e.g., by control logic 202) to establish an access profile 222 for a detected foreign domain. That is, if domain identifier 218 does not recognize a host domain (i.e., the domain is a foreign domain), control logic 202 (or, domain identifier 218) may invoke an instance of profile generator 220 to create an access profile for the foreign domain. According to one example embodiment, the access privileges associated with a foreign domain are restrictive, protecting the resources of the host appliance from other appliances within the domain.

To obtain information associated with the foreign domain, profile generator 220 may query one or more elements of the foreign domain for one or more of access information (e.g., communication parameters) as well as resource information (e.g., active appliances). In this regard, profile generator 220 may well invoke the features of transceiver 216, as described above. According to one example embodiment, profile generator 220 invokes a user interface (e.g., application 210) to solicit user assistance in obtaining such information about the newly detected domain. Based, at least in part, on the information accumulated by profile generator 220, an access profile associated with the foreign domain is created and stored in memory 222. Upon the generation of an access profile 222, control logic 202 selectively modifies one or more operational parameters of the host appliance, as defined in the access profile, to facilitate operation within the identified domain. According to one embodiment, one or more of the operational parameters are modified in cooperation with an operating system (OS) of the host appliance.

Input/output (IO) interface(s) 206 are intended to cover a wide variety of wired and wireless IO interfaces that enable one or more elements of configuration agent 200 to communicate with other elements of, e.g., a host appliance (e.g., microprocessor), a host domain, etc. According to one example embodiment, IO interface(s) 206 include the physical hardware and software features that enable configuration agent 200 to communicate over wired 214 and/or wireless 212 communication hardware, in accordance with any of a number of communication protocols.

Similarly, memory 208 may represent any of a wide variety of volatile and/or non-volatile storage technologies, suitable for use by control agent 200 to store one or more access profile(s) 222. But for the storage of access profiles 222 in support of embodiments of the present invention, memory 208 is intended to reflect any of a number of known memory storage technology and, as such, need not be described further herein.

### Operational Example(s)

Having introduced the operating environment and architectural elements of the configuration agent 200, above, attention is now directed to FIG. 3 where an operational example implementation is presented, according to one example embodiment of the invention. For ease of illustration, and not limitation, the method of FIG. 3 is developed with continued reference to FIGS. 1 and 2, as appropriate. Nonetheless, it is to be appreciated that the teachings of FIG. 3 may well be implemented in alternate operational environment(s)/configuration agent architecture(s) without deviating from the spirit and scope of the present invention.

FIG. 3 is a flow chart of an example method of dynamic appliance configuration, according to one example embodiment of the invention. In accordance with the illustrated example embodiment of FIG. 3, the method 300 begins with block 302, wherein an electronic appliance (e.g., 128) may receive indication(s) (heartbeat) associated with operating domain(s) (e.g., home domain 102). More particularly, configuration agent 200 of a host electronic appliance (128) receives the indication at a receiver element of transceiver 216 from, e.g., antenna(e) 212.

In response, control logic 202 of configuration agent 200 invokes an instance of domain identifier function 218 to determine an identity of the domain(s) associated with the received indication(s), block 304. According to one example embodiment, domain identifier function 218 reads at least a subset of the received indication for information denoting the host domain(s) generating such signal(s). As used herein, domain identifier function 218 may discern a domain based, at least in part, on one or more of a domain identifier, an identifier of an appliance generating the indication, a media access controller (MAC) address, a network address, and the like.

If, in block 306, domain identifier function 218 resolves the domain identity from the received indication, domain identifier function 218 issues a request to memory 208 for an access profile 222 associated with the detected domain, block 308. According to one embodiment, the memory request may be issued to/through control logic 202.

According to one example embodiment, before adopting the new configuration settings detailed in the access profile 222, configuration agent 200 may challenge the domain to authenticate its identity, block 310. That is, in one embodiment, control logic 202 may challenge the identified domain using security information (e.g., a key) associated with the identified domain and maintained in the access file 222. According to one embodiment, the challenge may be issued to a domain access controller (not particularly denoted) integrated within or otherwise associated with an appliance in the domain via a transmitter element of transceiver 216.

If in block 310, configuration agent 200 receives an improper response (e.g., an unexpected response to the challenge), configuration agent 200 may default to a secure access profile. According to one example embodiment, the secure access profile prohibits access by members of the domain to the resources of the host electronic appliance (e.g., 128). According to one embodiment, control logic 202 may prompt the user of the host appliance with an indication of authentication failure, directing the user to seek technical assistance to resolve the problem.

If, in block 310, configuration agent 200 receives a proper response (e.g., an expected response to the challenge), the process continues with block 314 wherein control logic 202 may selectively modify one or more operating characteristics of a host appliance (e.g., 128) to reflect the configuration information contained within the access profile 222. As introduced above, the operating characteristics may well include one or more of access privileges, communication parameters (e.g., communication frequency, protocol, identifier within one or more networks, etc.), application availability, user interface settings, and the like. In this regard, certain of the settings may be set by control logic 202 in cooperation with an operating system (OS) executing on the host appliance.

In block 316, selective modification of the configuration parameters in accordance with the configuration information contained within the access profile 222 enables the host appliance (128) to participate in, and share resources among, other appliances within the domain. Such communication is enabled until the host appliance is turned off, or until configuration agent 200 receives an indication associated with a new domain, i.e., the host appliance is moved to another operating domain, where the process returns to block 302.

Returning to block 306, if domain identifier 218 is unable to resolve the identity of the domain associated with a received indication, control logic 202 may provide a user with an opportunity to add the detected foreign domain to its list of identified domains. According to one example embodiment, control logic 202 may invoke an application 210 to provide a user interface (e.g., visual or audible) through which a user may elect to add the new domain, block 318.

If, in block 318, the user (or, alternatively control logic 202 independently) decides not to add the new domain, the process continues with block 312, wherein control logic 202 invokes a secure access profile to protect the host appliance (e.g., 128) from access by other appliances/resources within the domain.

Alternatively, if in block 318 the user (or, alternatively control logic 202 independently) decides to add the new domain, profile generator function 220 generates a query for transmission to one or more elements (e.g., computing appliances, networking appliances, other resources, etc.) of the domain for configuration and/or access information associated with the domain, block 320. According to one embodiment, the query may be transmitted through transmission elements of transceiver 216 and antenna(e) 212.

Based, at least in part, on the response(s) received to the transmitted query, profile generator 220 may create an access profile 222 suitable to enable a host appliance (e.g., 128) to access and share information among at least a subset of the elements comprising the domain, block 322. Once the profile is created, the process continues with block 314, where control logic 202 selectively modifies one or more operating characteristics of the host appliance (128) to enable access to the newly identified domain.

FIG. 4 is a block diagram of an example electronic appliance 400 suitable for use in accordance with one example embodiment of the present invention. In accordance with the illustrated example embodiment of FIG. 4, electronic appliance 400 is depicted comprising one or more of controller(s) 402, system memory 406, a display interface 408 and associated display device 410, one or more input/output interface(s) 412 and associated peripheral (e.g., keyboard and/or pointing) devices 414, network interface(s) 416, storage device(s) 418 and, in alternate embodiments, configuration agent 200 incorporating the teachings of the present invention, coupled as depicted. As shown, system memory includes random access memory (RAM) 420 and read-only memory (ROM) 422. RAM 420 is depicted comprising applications 424 including, in accordance with one embodiment, an application to implement the configuration agent 200 presented above, and data 426. In this regard, configuration agent 200 may well be implemented in hardware, software, firmware or a combination thereof.

As used herein, but for the introduction of configuration agent 200 and the capability associated therewith, electronic appliance 400 is intended to represent any of a wide variety of electronic appliances know in the art including, but not limited to computing devices, communication devices, home appliances, multimedia appliances, networking appliances, and the like. In this regard, electronic appliances 400 of greater or lesser complexity that nonetheless incorporate the teachings associated with configuration agent 200 are anticipated within the spirit and scope of the present invention.

According to one example embodiment, controller(s) 402 control the overall operation of electronic appliance 400. In this regard, controller(s) 402 may selectively invoke the application and communication features of the electronic appliance to support user activity of the appliance. According to one embodiment, controller(s) 402 may receive configuration information from configuration agent 200, that controller(s) 402 may use in configuring one or more operational characteristics of electronic appliance 400.

According to one embodiment, controller(s) 402 may selectively modify one or more configuration settings associated with display interface 408, I/O interface(s) 412, network interface(s) 416, storage device(s) 418 and/or application(s) 424 as described above based, at least in part, on an identity of a host domain detected by configuration agent 200. As introduced above, controller(s) 402 may modify one or more of such configuration settings through an operating system (OS) executing on the host appliance 400.

FIG. 5 is a block diagram of an example mode of operation enabled by configuration agent 200. In accordance with the illustrated example embodiment of FIG. 5, an operating topology 500 is depicted including at least three (3) appliances 502, 592 and 594. As shown, appliance 502 is a member of two different domains, domain X 510 and domain Y 550. Within each of the different domains 510 and domain 550, appliance 502 offers disparate resources, e.g., applications, data, communications, quality of service, etc. In accordance with the illustrated example embodiment, appliance 502 is depicted comprising different applications 520-540 and 560-580 within domains 510 and 520, respectively. As shown, configuration agent 200 (not particularly denoted) operating in at least appliance 502 enables the appliance to participate in both domains (510 and 520), while offering appliances 592 and 594 access to only that content which is consistent with their respective domain memberships.

### Alternate Embodiment(s)

It will be appreciated by those skilled in the art that the foregoing was but a mere illustration of the teachings of the present invention, as other embodiments and implementations are anticipated within the scope of the invention. Examples of such alternate embodiments are briefly described below.

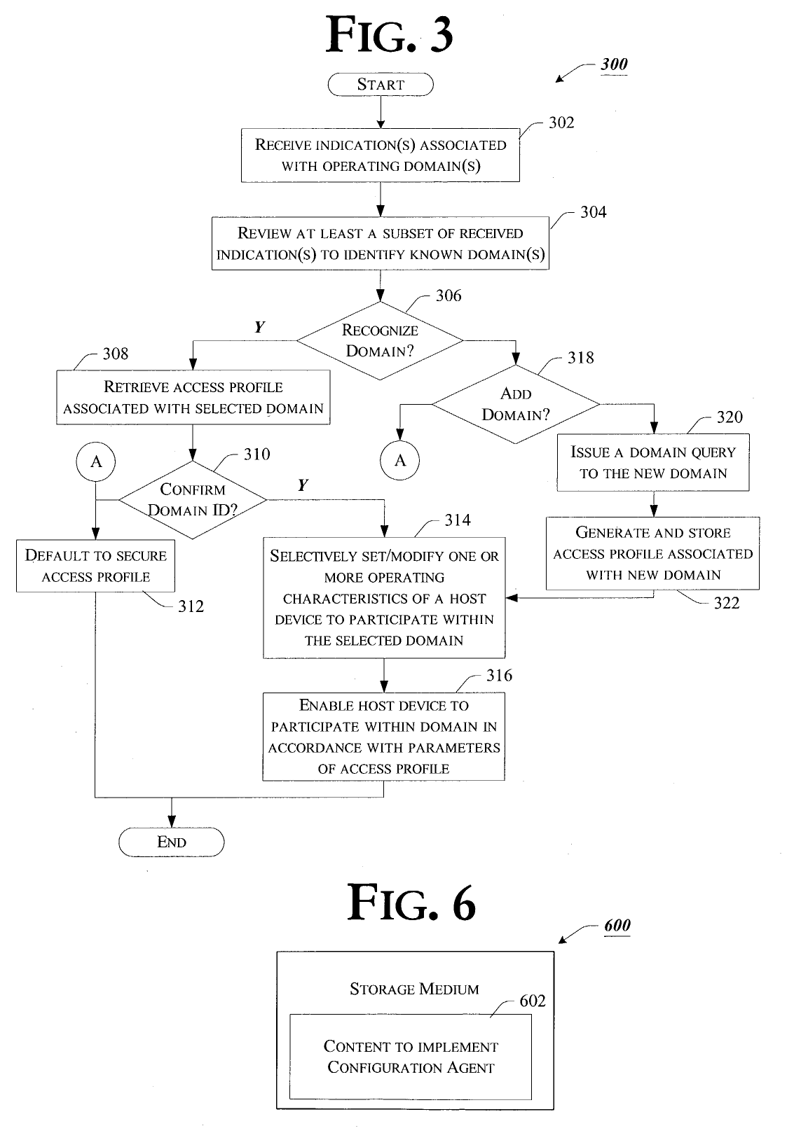

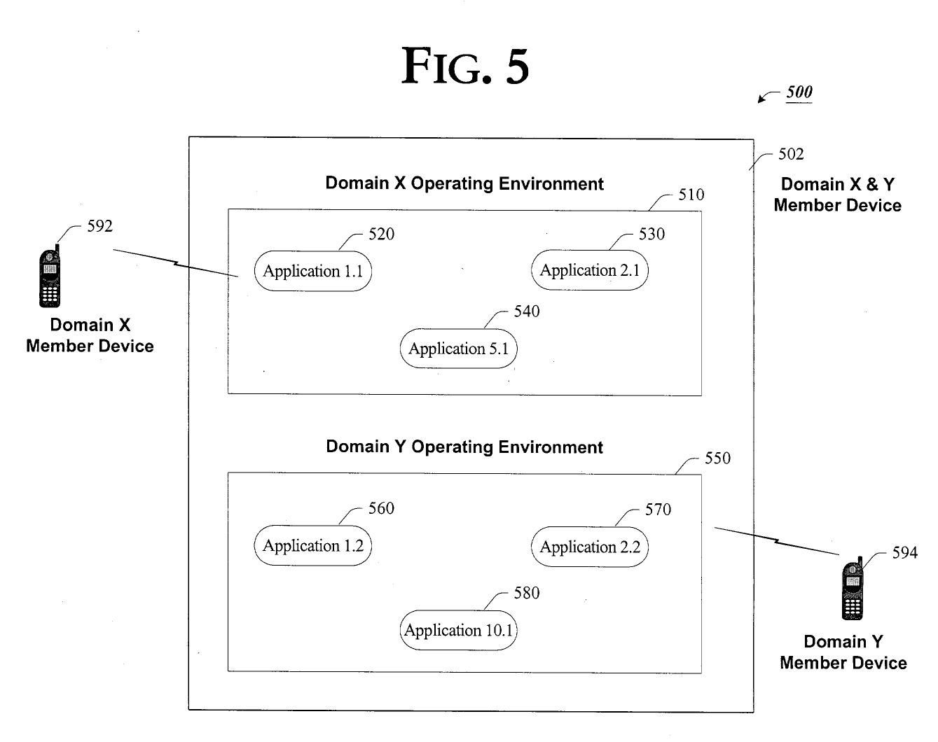

FIG. 6 is a block diagram of an example storage medium comprising executable content which, when executed by an accessing appliance, may cause the appliance to implement one or more aspects of the innovative configuration agent architecture 200 and/or associated methods 300. In this regard, storage medium 600 includes content 602 to implement a configuration agent architecture to detect an operating domain of a host appliance, and to selectively modify one or more configuration settings of the host appliance to access and utilize the resources of the detected host domain, in accordance with one embodiment of the present invention.

The machine-readable medium 600 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various operations. The operations of the present invention may be performed by hardware components, such as those shown in FIGS. 1, 2 and/or 4, or may be embodied in machine-executable content (e.g., instructions), which may be used to cause a general-purpose or special-purpose processor or logic circuits programmed with the instructions to perform the operations. Alternatively, the operations may be performed by a combination of hardware and software. Moreover, although the invention has been described in the context of a network device, those skilled in the art will appreciate that such functionality may well be embodied in any of number of alternate embodiments such as, for example, integrated within a computing device (e.g., a server).

Many of the methods are described in their most basic form but operations can be added to or deleted from any of the methods and information can be added or subtracted from any of the described messages without departing from the basic scope of the present invention. Any number of variations of the inventive concept are anticipated within the scope and spirit of the present invention.

In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
receiving an indication signal from an associated one or more domains, the indication signal including information from which domain identity is discernable; and
selectively modifying at least a subset of operating characteristics of an electronic appliance based, at least in part, on an identified domain.

2. A method according to claim 1, further comprising:
identifying a domain from the received indication signal based, at least in part, on a subset of information contained within the indication signal.

3. A method according to claim 2, wherein identifying comprises:
reading at least a subset of the received indication signal to recover discernable domain identity information embedded within the signal.

4. A method according to claim 3, wherein the reading at least a subset of the received indication signal recovers domain identity information including one or more of a domain identifier, an appliance identifier, a media access control (MAC) address, and a network address.

5. A method according to claim 1, wherein receiving comprises:
receiving two or more indication signals from an associated two or more domains; and
selecting one of the received indication signals for further processing based on one or more signal attributes.

6. A method according to claim 5, wherein selecting one of the received indication signals is based on one or more signal attributes comprising one or more of a receive signal strength, a signal to noise ratio, or content identified within the received signal.

7. A method according to claim 1, further comprising:
retrieving an access profile associated with the identified domain; and
reading the configuration settings maintained in the access profile.

8. A method according to claim 7, further comprising:
issuing a challenge to a domain access controller to authenticate the identity of the domain associated with the retrieved access profile.

9. A method according to claim 7, wherein selective modification of the operating characteristics includes modifying one or more operating characteristics of the host appliance to reflect the configuration settings maintained in the retrieved access profile.

10. A method according to claim 1, further comprising:
identifying a foreign domain based, at least in part, on the received indication signal; and
issuing a query to one or more elements of the foreign domain to retrieve configuration settings information used to generate an access profile associated with the foreign domain.

11. A method according to claim 10, further comprising:
invoking a user interface to enable a user to decide whether to generate an access profile for the foreign domain.

12. A method according to claim 10, further comprising:
generating an access profile associated with the foreign domain including at least the configuration settings information received from the one or more elements of the foreign domain in response to the issued query.

13. A method according to claim 1, wherein the received indication signals are generated in support of unrelated domain activity, or applications.

14. A method according to claim 13, wherein the unrelated domain activity is the generation of a broadcast signal in support of a wireless local area network (WLAN).

15. A method according to claim 1, wherein the selectively modified operating characteristics expire after a predetermined period of time.

16. A method according to claim 15, wherein the operating characteristics selectively modified operating characteristics return to a pre-modified state upon the expiration of the time period.

17. A method according to claim 1, wherein the selective modification of one or more operating characteristics in accordance with an identified domain enables a differentiated Quality of Service (QoS) as compared to other operating domains.

18. An apparatus comprising:
a receiver, to receive indication signals from one or more domains, the indication signals including information from which domain identity is discernable; and
a domain identifier, responsive to the receiver, to analyze at least a subset of received indication signal to identify a host domain and selectively modify one or more operating characteristics of a host appliance based, at least in part, on the identified domain.

19. An apparatus according to claim 18, further comprising:
a memory element, coupled with the domain identifier, to maintain access profiles, at least one each for each domain known to the apparatus.

20. An apparatus according to claim 19, wherein the access profiles include configuration information to enable a host electronic appliance to communicate with and share content between at least a subset of electronic appliances within an associated domain.

21. An apparatus according to claim 18, further comprising:
a profile generator, responsive to the domain identifier function, selectively invoked to generate an access profile when a foreign domain is detected.

22. An apparatus according to claim 21, further comprising:
a transmitter, responsive to the profile generator, to transmit a query generated by the profile generator to one or more elements of the foreign domain to retrieve at least communication configuration information.

23. An apparatus according to claim 22, wherein the communication configuration information is supplemented with user preferences in generating an access profile associated with the foreign domain.

24. A system comprising:
one or more dipole antenna(e), to detect an indication signal from a domain; and
a configuration agent, responsive to the anntena(e), to analyze at least a subset of the detected indication signals for information from which domain identity is discernable, to identify the domain, and selectively modify one or more operating characteristics of the system for use within the identified domain.

25. A system according to claim 24, the configuration agent comprising:
a receiver, to receive indication signals from one or more domains, the indication signals including information from which domain identity is discernable; and
a domain identifier function, responsive to the receiver, to analyze at least a subset of received indication signal to identify a host domain and selectively modify one or more operating characteristics of a host appliance based, at least in part, on the identified domain.

26. A system according to claim 25, the configuration agent further comprising:
a memory element, coupled with the domain identifier function, to maintain access profiles, at least one each for each domain known to the apparatus.

27. A system according to claim 26, wherein the access profiles include configuration information to enable a host electronic appliance to communicate with and share content between at least a subset of electronic appliances within an associated domain.

28. A storage medium comprising content which, when executed by an accessing electronic appliance causes the appliance to implement a method including, at least in part,
receiving an indication signal from an associated one or more domains, the indication signal including information from which domain identity is discernable; and
selectively modifying at least a subset of operating characteristics of an electronic appliance based, at least in part, on an identified domain.

29. A storage medium according to claim 28, the content to implement the method further comprising:
identifying a domain from the received indication signal based, at least in part, on a subset of information contained within the indication signal.

30. A storage medium according to claim 28, the content to implement the method further comprising:
retrieving an access profile associated with the identified domain; and
reading the configuration settings maintained in the access profile.

31. A storage medium according to claim 30, the content to implement the method further comprising:
instructing the accessing machine to modify one or more operating characteristics in accordance with at least a subset of the configuration settings read from the retrieved access profile.
